(19) United States
(12) Patent Application Publication
(10) Pub. No.: US 2024/0409826 A1
(43) Pub. Date: Dec. 12, 2024

(54) METHOD FOR PURIFYING HYDROCARBON FEEDSTOCK AND USE THEREOF

(71) Applicant: TotalEnergies One Tech, Courbevoie (FR)

(72) Inventors: Thomas COUSTHAM, Ablon (FR); Christine LEGRAND, Lanquetot (FR); Hélène COULOMBEAU-LEROY, Montivilliers (FR)

(73) Assignee: TotalEnergies One Tech, Courbevoie (FR)

(21) Appl. No.: 18/289,324

(22) PCT Filed: May 2, 2022
(86) PCT No.: PCT/FR2022/050844

§ 371 Date: Nov. 2, 2023

(30) Foreign Application Priority Data
May 3, 2021 (FR) FR2104617

(51) Int. Cl. C10G 53/12; C10G 29/04; C10G 55/06

(52) U.S. Cl. CPC C10G 53/12; C10G 29/04; C10G 55/06

(57) ABSTRACT

A method for purifying a composition comprising a plastic pyrolysis oil comprising a treatment with a strong base in the solid state and washing with water. The method is useful for reducing the concentration of heteroelements in said composition with a view to making it compatible for introduction as feedstock in conversion methods such as steam cracking, fluid catalytic cracking, catalytic hydrogenation or hydrocracking.

### TECHNICAL FIELD OF THE INVENTION

The present invention relates to a method for purifying hydrocarbon feedstock and the subsequent use thereof in refining and petrochemical processes. The method according to the invention allows purifying feedstocks containing plastic pyrolysis oils, in particular in order to use them in a steam cracking method.

### TECHNOLOGICAL BACKGROUND

Patent JP3776335 discloses a method for dechlorinating and denitrogenating an oil resulting from the catalytic or thermal cracking of plastic waste which is treated at different temperatures up to 425° C. for 30 minutes in the presence of an aqueous solution of an alkaline compound of an alkali or alkaline earth metal at a pH which is greater than or equal to 7. All natural non-radioactive alkali or alkaline earth metal hydroxides are tested. The product of the reaction is then separated from the alkaline aqueous solution by liquid-liquid separation with ethyl ether.

Patent application WO2012/069467 claims a method for eliminating siloxanes contained in a plastic pyrolysis oil by heat treatment between 200 and 350° C. in the presence of an alkali metal hydroxide in the solid state or in solution. The use of calcium hydroxide at 5% by weight at 225° C. does not allow obtaining a reduction in the siloxane content (table 5, p.12 and lines 9 to 11, p.13). At the end of the reaction, the pyrolysis oil is separated by distillation under reduced pressure.

Patent FI128848 describes a method sequence comprising a heat treatment of a plastic pyrolysis oil at at least 200° C. in the presence of an alkaline aqueous solution. At the end of the reaction, the pyrolysis oil is separated from the alkaline aqueous phase. A final hydrotreatment allows obtaining a steam cracker feedstock which is optionally washed with an acid solution before introduction into the steam cracker.

Patent application WO2020/02769 claims a sequence of method for purifying a composition comprising at least ppm of chlorine. Many recyclable liquid wastes can be treated, including plastic pyrolysis oils. The method sequence comprises a heat treatment of the feedstock in the presence of an alkali metal hydroxide in order to obtain a reduction of at least 50% in the chlorine content relative to the feedstock, followed by a hydrotreatment in order to obtain a new reduction of at least 50% in the chlorine content.

These documents do not have alternative means for purifying the plastic pyrolysis oil.

### SUMMARY OF THE INVENTION

The invention aims at proposing a method for purifying plastic pyrolysis oil allowing facilitating the purification thereof by allowing high reduction performance.

To this end, the invention relates to a method for reducing the concentration of heteroatoms of a composition comprising a plastic pyrolysis oil containing at least 20 ppm by mass of chlorine as measured according to standard ASTM D7359-18, comprising:
(a). contacting said composition with 0.1-50% by mass of a strong base comprising an alkali or alkaline earth metal cation in the solid state, for at least 1 minute at a temperature of at most 450° C.,
(b). a separation between the strong base comprising the alkali or alkaline earth metal cation and the product resulting from contacting said composition by washing with a polar solvent immiscible with the product resulting from step (a).

In particular, step (a) is implemented without adding any solvent other than that which is optionally already present in the composition. In other words, during step (a), the strong base is preferably added in solid form and not in solution.

Step (b) can be carried out at a temperature of 0 to 60° C., preferably of 0° to 40° C., more preferably of 0° to 30° C., in particular without external heating. The washing is typically implemented at atmospheric pressure.

During step (b), the volume ratio of the polar solvent to the product resulting from step (a) can be from 10/90 to 90/10, preferably from 30/70 to 70/30, in particular from 40/60 to 60/40, or in an interval defined by any combination of the aforementioned limits.

The composition may further comprise a biomass pyrolysis oil such as Panicum virgatum, a tall oil, a waste edible oil, an animal fat, a vegetable oil such as rapeseed, canola, castor, palm, soybean oil, an oil extracted from an algae, an oil extracted from a fermentation of oleaginous microorganisms such as oleaginous yeasts, a biomass pyrolysis oil such as a lignocellulosic biomass such as a wood, paper and/or cardboard pyrolysis oil, an oil obtained by pyrolysis of crushed used furniture, elastomers for example optionally vulcanised latex, as well as mixtures thereof.

The composition can comprise at least 2% by weight of a plastic pyrolysis oil. The remainder can then be composed of at most 98% by mass of a diluent or solvent such as a hydrocarbon and/or of one or more of the components listed above.

The method can further comprise a step in which:
(c) the product resulting from the washing in step (b) is subjected to a (i) filtration, (ii) distillation, (iii) extraction with a solvent, or (iv) the combination of two or three of steps (i) to (iii).

The contact is preferably performed for a period of 1 minute to 48 hours, preferably of 5 minutes to 2 hours, at a temperature of 50 to 450° C., preferably of 90 to 350° C., more preferably of 150 to 350° C. and at an absolute pressure of 0.1 to 100 bars, preferably of 1 to 50 bars.

The washing of step (b) can be performed with a polar solvent immiscible with the product resulting from step (a) selected from (i) glycol ethers, including in particular polyethylene glycol of chemical formula HO—(CH₂—CH₂—O)ₙ—H with a mass average molar mass of 90 to 800 g/mol, for example diethylene glycol and tetraethylene glycol, polypropylene glycol of chemical formula H[OCH(CH₃)CH₂]ₙOH with a mass average molar mass of 130 to 800 g/mol, for example dipropylene glycol and tetrapropylene glycol, (ii) dialkyl formamides, in which the alkyl group can comprise 1 to 8 or 1 to 3 carbon atoms, in particular N, N-dimethyl formamide (DMF), (iii) dialkyl sulfoxides, in which the alkyl group can comprise 1 to 8 or 1 to 3 carbon atoms, in particular dimethyl sulfoxide (DMSO) and sulfolane, (iv) the compounds comprising a furan ring, (v) cyclic carbonate esters, comprising in particular 3 to 8 or 3 to 4 carbon atoms, in particular propylene carbonate and ethylene carbonate, (vi) water and mixtures thereof.

A preferred polar solvent, used alone or mixed with water, may be a glycol ether, in particular polyethylene glycol of chemical formula HO—(CH₂—CH₂—O)ₙ—H with a mass average molar mass of 90 to 800 g/mol or polypropylene glycol of chemical formula H[OCH(CH₃)CH₂]ₙOH with a mass average molar mass of 130 to 800 g/mol, or a compound comprising a furan ring, or a cyclic carbonate ester, in particular propylene or ethylene carbonate.

In a preferred embodiment, the polar solvent can be selected from propylene carbonate, ethylene carbonate, polyethylene glycol of chemical formula HO—(CH₂—CH₂—O)ₙ—H with a mass average molar mass of 90 to 800 g/mol, alone or mixed with water.

The washing of step (b) is preferably performed with water.

The used water can have an acidic, basic or neutral pH. An acidic pH can be obtained by addition of one or more organic or inorganic acids. Examples of usable organic acids comprise citric acid (C₆H₈O₇), formic acid (CH₂O₂), acetic acid (CH₃COOH), sulfamic acid (H₃NSO₃). Examples of inorganic acids are hydrochloric acid (HCL), nitric acid (HNO₃), sulfuric acid (H₂SO₄), phosphoric acid (H₃PO₄). A basic pH can be obtained by addition of alkali and alkaline earth metal oxides, alkali and alkaline earth hydroxides (for example NaOH, KOH, Ca(OH)₂) and amines (for example triethylamine, ethylenediamine, ammonia).

A preferred strong base can be selected from LiOH, NaOH, CsOH, Ba(OH)₂, Na₂O, KOH, K₂O, Cao, Ca(OH)₂, MgO, Mg(OH)₂ and mixtures thereof.

The invention can also comprise an additional step in which:
(d) the product resulting from step (b) or (c) undergoes a catalytic hydrogenation in one or two steps.

In the case where the catalytic hydrogenation is performed in two steps, step (d) is performed in a first step (d-1) in which the product resulting from step (b) or (c) is hydrogenated at a temperature comprised between 2° and 200° C., preferably between 3° and 90° C. in the presence of hydrogen at an absolute pressure comprised between 5 and 60 bars, preferably between 20 and 30 bars and in the presence of a hydrogenation catalyst comprising Pd (0.1-10% by weight) and/or Ni (0.1-60% by weight) and/or NiMo (0.1-60% by weight) and in a second step (c-2) in which the effluent resulting from step (c-1) is hydrogenated at a temperature comprised between 200 and 450° C., preferably between 20° and 340° C. in the presence of hydrogen at an absolute pressure comprised between 20 and 140 bars, preferably between 30 and 60 bars and in the presence of a hydrogenation catalyst comprising NiMo (0.1-60% by weight) and/or CoMo (0.1-60% by weight).

The product resulting from step (b) or (c) or the effluent resulting from step (d) is preferably purified by passing over a solid adsorbent in order to reduce the content of at least one element from F, Cl, Br, I, O, N, S, Se, Si, P, As, Fe, Ca, Na, K, Mg and Hg and/or the water content.

The adsorbent can be operated in regenerative or non-regenerative mode, at a temperature which is lower than 400° C., preferably lower than 100° C., more preferably lower than 60° C. selected from: (i) a silica gel, (ii) a clay, (iii) a pounded clay, (iv) apatite, hydroxyapatite and the combinations thereof, (vi) an alumina for example an alumina obtained by precipitating boehmite, a calcined alumina such as Ceralox® from Sasol, (vii) boehmite, (viii) bayerite, (ix) hydrotalcite, (x) spinel such as Pural® or Puralox from Sasol, (xi) a promoted alumina, for example Selexsorb® from BASF, an acid promoted alumina, an alumina promoted by a zeolite and/or by a metal such as Ni, Co, Mo or a combination of at least two of them, (xii) an acid-treated clay such as Tonsil® from Clariant, (xiii) a molecular sieve in the form of an aluminosilcate containing an alkali or alkaline earth cation for example the sieves 3A, 4A, 5A, 13X, for example marketed under the brand Siliporite® from Ceca, (xiv) a zeolite, (xv) an activated carbon, or the combination of at least two adsorbents, the adsorbent or the at least two adsorbents retaining at least 20% by weight, preferably at least 50% by weight of at least one element from F, Cl, Br, I, O, N, S, Se, Si, P, As, Fe, Ca, Na, K, Mg and Hg and/or water.

According to a preferred embodiment, the adsorbent is regenerative, has a specific surface area of at least 200 m²/g and is operated in a fixed bed reactor at less than 100° C. with a HSV of 0.1 to 10 h⁻¹.

According to an additional embodiment, at least one portion of the product resulting from step (b) or the effluent resulting from step (c) or (d) can be:
(e) treated in a steam cracker, and/or
(f) treated in a fluidised bed catalytic cracker, or
(g) treated in a hydrocracker, and/or
(h) treated in a catalytic hydrogenation unit, and/or
(i) used as is or separated into streams usable for the preparation of fuels and combustibles such as LPG, gasoline, diesel, heavy fuel oil and/or for the preparation of lubricants.

### Definitions

The Hourly Space Velocity (HSV) is defined as the hourly volume of feedstock stream per unit of catalyst volume and is expressed here in h⁻¹.

The terms “comprising” and “comprises” as used here are synonymous with “including”, “includes” or “contains”, “containing”, and are inclusive or without limitations and do not exclude additional characteristics, elements or steps of methods which are not specified.

The specification of a numerical domain without decimals includes all integers and, where appropriate, fractions thereof (for example, 1 to 5 can include 1, 2, 3, 4 and 5 when referring to a number of elements, and can also include 1.5, 2, 2.75 and 3.80, when referring to, for example, a measurement.)

Specifying a decimal also comprises the decimal itself (for example, “from 1.0 to 5.0” includes 1.0 and 5.0). Any range of numerical values recited here also comprises any subrange of numerical values mentioned above.

The expressions % by weight and % by mass have an equivalent meaning and refer to the proportion of the mass of a product relative to 100 g of a composition comprising it.

Unless otherwise stated, the measurements given in parts per million (ppm) are expressed by weight.

The acronym LPG corresponds to the expression Liquefied Petroleum Gas and the definition commonly accepted in the industry which refers to a cut of hydrocarbons essentially consisting of C3 (mainly propane) with a few C4 isomers including mainly n-butane and isobutene.

The expression “plastic pyrolysis oil” or “oil resulting from plastic pyrolysis” refers to the liquid products obtained at the end of a pyrolysis of thermoplastic, thermosetting or elastomeric polymers, alone or in mixture and generally in the form of waste. The pyrolysis process should be understood as a non-selective thermal cracking process. Pyrolysed plastic can be of any type. For example, the plastic to be pyrolysed can be polyethylene, polypropylene, polystyrene, polyester, polyamide, polycarbonate, etc. These plastic pyrolysis oils contain paraffins, i-paraffins (iso-paraffins), dienes, alkynes, olefins, naphthenes and aromatics. The plastic pyrolysis oils also contain impurities such as chlorinated, oxygenated and/or silylated organic compounds, metals, salts, phosphorus, sulphur and nitrogen compounds.

The composition of the plastic pyrolysis oil is dependent on the nature of the pyrolysed plastic and essentially consists of hydrocarbons having 1 to 50 carbon atoms and impurities.

The expression “MAV” (acronym for “Maleic Anhydric Value”) refers to the UOP326-82 method which is expressed in mg of maleic anhydride which reacts with 1 g of sample to be measured.

The expression “Bromine number” corresponds to the amount of bromine in grams reacted on 100 g of sample and can be measured according to ASTM D1159-07 method.

The expression “Bromine Index” is the number of miligrams of bromine which react with 100 g of sample and can be measured according to ASTM D2710 or ASTM D5776 methods.

The expression “polar solvent immiscible with the product resulting from step (a)” within the meaning of the present patent application, corresponds to a polar solvent forming a heterogeneous mixture with said product. It will be possible to consider as immiscible with the product, a solvent for which a rate defined as the ratio of the volume of polar solvent after washing to the volume of initial polar solvent which is greater than or equal to 0.95 is obtained, the volume of polar solvent after washing corresponding to phase containing said polar solvent, immiscible with the product resulting from step (a) and recovered after stirring then decanting a mixture of a part by volume of polar solvent with twenty-five parts by volume of said product at atmospheric pressure and at a temperature of 20° C.

The expression “polar solvent” within the meaning of the present patent application covers all chemical species, alone or in mixture, capable of solvating a composition comprising a plastic pyrolysis oil, and including at least one carbon-hydrogen, carbon-halogen, carbon-chalcogen or carbon-nitrogen covalent bond and having a non-zero dipole moment. Acceptable polar solvents include compositions comprising hydrocarbon compounds which include heteroatoms in their molecular structure, for example (i) glycol ethers such as polyethylene glycol (PEG), ethylene glycol, tetraethylene glycol, polypropylene glycol, for example a PEG with an average molar mass of 200 g/mol, (ii) nitrogen compounds, for example N, N-dimethyl formamide, (iii) sulphur compounds, for example sulfolane or dimethyl sulfoxide, (iv) the compounds comprising a furan ring (v) carbonate esters such as propylene carbonate and ethylene carbonate.

It is understood that the term “polar solvent” within the meaning of the present definition includes water.

The term “solvent” includes the aforementioned “polar solvents” and the nonpolar solvents, which comprise for example any type of saturated or unsaturated linear, branched, cyclic and/or aromatic hydrocarbon such as pentane, cyclohexane, oct-1-ene, toluene or p-xylene or certain other solvents with zero dipole moment such as tetrachloromethane or carbon disulphide.

The choice of the solvent is made by tests with conventional techniques known to the person skilled in the art and depends on the nature of the feedstock to be solvated and the impurities to be eliminated.

Boiling points as mentioned here are measured at atmospheric pressure unless otherwise stated. An initial boiling point is defined as the temperature value from which a first vapour bubble is formed. A final boiling point is the highest temperature achievable during a distillation. At this temperature, no more vapour can be transported to a condenser. The determination of the initial and final points uses techniques known in the art and several methods adapted depending on the range of distillation temperatures are applicable, for example NF EN 15199-1 (version 2020) or ASTM D2887 for measuring the boiling points of petroleum: fractions by gas chromatography, ASTM D7169 for heavy hydrocarbons, ASTM D7500, D86 or D1160 for distillates.

The concentration of metals in hydrocarbon matrices can be determined by any known method. Acceptable methods include X-ray fluorescence (XRF) and inductively coupled plasma atomic emission spectrometry (ICP-AES). The specialists in analytical sciences know how to identify the most suitable method for measuring each metal and each heteroelement depending on the considered hydrocarbon matrix.

The particular features, structures, properties, embodiments of the invention can be freely combined into one or more embodiments not specifically described here, as may be apparent to specialists in the treatment of plastic pyrolysis oils implementing their general knowledge.

### DESCRIPTION OF THE INVENTION

### Examples

The embodiments of the present invention are illustrated by the following non-limiting examples.

### Example 1: Purification of Two Plastic Pyrolysis Oils in the Presence of a Strong Base and an Alcohol

Two different plastic pyrolysis oils, whose physicochemical characteristics are described in Table 1, below, are used:

TABLE 1

| | Pyrolysis oil | |
|---|---|---|
| | HPP1 | HPP2 |
| Density (g/mL) | 0.741 | 0.800 |
| Kinematic viscosity (15° C. mm²/s) | 0.70 | 2.1 |
| Distillation, initial point (° C.) | <36 | 69 |
| Distillation, 50% (° C.) | 131 | 214 |
| Distillation, end point (° C.) | 259 | 451 |
| Silicon (ppm by mass) | 72 | 82 |
| Chlorine (ppm by mass) | 50 | 96 |
| Oxygen (% by mass) | 1.6 | 0.87 |
| Nitrogen (ppm by weight) | 129 | 206 |
| Sulphur (ppm by weight) | 11 | 19 |

### Test Protocol:

A 1.5 L AISI-316L grade stainless steel autoclave equipped with a mechanical stirring is loaded with a pyrolysis oil selected from HPP1 and HPP2, a strong base in the form of NaOH and optionally a solvent or water, according to the tests carried out (Table 2). The sum of the volume of pyrolysis oil and the volume of solvent or water which are introduced is equal to 600 mL at ambient temperature, without taking into account the possible effects of volume variation during their mixing. The autoclave is closed and the gas in the autoclave is flushed with nitrogen for 30 minutes. The autoclave is then heated under autogenous pressure with stirring at a speed of 400 to 1500 rpm at a temperature of 225° C. for a period of 30 minutes, once the target temperature has been reached. The temperature rise speed is set at 30° C./10 minutes.

TABLE 2

| Test | 1 | 2 | 3 | 4 | 5 | 6 | 7 |
|---|---|---|---|---|---|---|---|
| Pyrolysis | HPP1 | HPP2 | HPP2 | HPP2 | HPP2 | HPP2 | HPP2 |
| oil | | | | | | | |
| Solvent or | — | — | Water | Water | Methanol | Ethanol | Isopropanol |
| water | | | | | | | |
| Solvent/feed | — | — | 0.02 | 0.53 | 0.53 | 0.53 | 0.53 |
| stock ratio | | | | | | | |
| volume of | 0 | 0 | 14 | 209 | 191 | 191 | 191 |
| solvent or | | | | | | | |
| water (mL) | | | | | | | |
| Mass of NaOH | 22.2 | 24.0 | 14.0 | 4.2 | 3.8 | 3.8 | 3.8 |
| (g) | | | | | | | |
| Mass of | 444.7 | 480.1 | 468.9 | 312.9 | 287.0 | 286.0 | 286.0 |
| pyrolysis | | | | | | | |
| oil (g) | | | | | | | |
| Initial | 741.2 | 800.2 | 800.2 | 800.2 | 800.2 | 800.2 | 800.2 |
| density | | | | | | | |
| (g/mL) | | | | | | | |
| Final | 746.4 | 792.8 | 793.1 | 793.7 | 792.9 | 793.0 | 792.2 |
| density | | | | | | | |
| (g/mL) | | | | | | | |
| Final | 12 | 5 | 12 | 27 | 45 | 31 | 24 |
| pressure | | | | | | | |
| in the | | | | | | | |
| autoclave | | | | | | | |
| (bars) | | | | | | | |

At the end of the reaction, the autoclave is cooled to room temperature then the mixture is unloaded and washed three times with water with, at each wash, a water/feedstock volume ratio=40/60, in order to eliminate the strong base residue and the water-soluble impurities. The resulting purified and washed pyrolysis oil is analysed to measure the residual impurity content (Table 3).

TABLE 3

| Test | 1 | 2 | 3 | 4 | 5 | 6 | 7 |
|---|---|---|---|---|---|---|---|
| Pyrolysis | HPP1 | HPP2 | HPP2 | HPP2 | HPP2 | HPP2 | HPP2 |
| oil | | | | | | | |
| Initial | 72 | 82 | 82 | 82 | 82 | 82 | 82 |
| silicon | | | | | | | |
| (ppm by | | | | | | | |
| weight) | | | | | | | |
| Final | 2 | <2 | <2 | 17 | 2 | 3 | 3 |
| silicon | | | | | | | |
| (ppm by | | | | | | | |
| weight) | | | | | | | |
| Silicon | 97 | >98 | >98 | 79 | 98 | 96 | 96 |
| reduction | | | | | | | |
| (%) | | | | | | | |
| Initial | 50 | 96 | 96 | 96 | 96 | 96 | 96 |
| chlorine | | | | | | | |
| (ppm by | | | | | | | |
| weight) | | | | | | | |
| Final | 17 | 14 | 16 | 16 | 15 | 17 | 22 |
| chlorine | | | | | | | |
| (ppm by | | | | | | | |
| weight) | | | | | | | |
| Chlorine | 66 | 85 | 83 | 83 | 84 | 82 | 77 |
| reduction | | | | | | | |
| (%) | | | | | | | |
| Initial | 1.6 | 0.87 | 0.87 | 0.87 | 0.87 | 0.87 | 0.87 |
| oxygen | | | | | | | |
| (ppm by | | | | | | | |
| weight) | | | | | | | |
| Final | 0.04 | 0.06 | 0.08 | 0.15 | 0.13 | n.d. | 0.08 |
| oxygen | | | | | | | |
| (ppm by | | | | | | | |
| weight) | | | | | | | |
| Oxygen | 98 | 93 | 91 | 83 | 85 | n.d. | 91 |
| reduction | | | | | | | |
| (%) | | | | | | | |
| Initial | 129.0 | 206.4 | 206.4 | 206.4 | 206.4 | 206.4 | 206.4 |
| nitrogen | | | | | | | |
| (ppm by | | | | | | | |
| weight) | | | | | | | |
| Final | 16.6 | 31.1 | 31.7 | 47.8 | 31.5 | n.d. | 33.0 |
| nitrogen | | | | | | | |
| (ppm by | | | | | | | |
| weight) | | | | | | | |
| Nitrogen | 87 | 85 | 85 | 77 | 85 | n.d. | 84 |
| reduction | | | | | | | |
| (%) | | | | | | | |

n.d.: not determined

A better reduction is observed in particular for silicon and nitrogen when the reaction is carried out in the presence of an alcohol (tests 5 to 7) relative to the use of water (test 4), at almost equivalent concentration of soda (a little more concentrated when the soda is in solution in water).

Furthermore, test 2 shows that the use of solid soda allows a better reduction of chlorine, oxygen and nitrogen than when the soda is in solution, whether in water or in an alcohol, while allowing an excellent reduction of silicon, equivalent to test 3 when the soda is in solution at 50% by weight in water.

An analysis of some other elements and properties was conducted and is presented in Table 4, below:

TABLE 4

| | Test | | |
|---|---|---|---|
| | HPP2 | 3 | 7 |
| Ca (mg/kg) | 0.3 | <0.25 | <0.25 |
| Fe (mg/kg) | 2.2 | 0.5 | 1.2 |
| Na (mg/kg) | <2.0 | <2.0 | <2.0 |
| P (mg/kg) | 1.6 | <0.25 | <0.25 |
| S (ppm by weight) | 19.3 | 10.5 | 11 |
| S reduction (%) | — | 46 | 43 |
| MAV (mg of maleic anhydride) | 13.9 | 12.8 | 14.7 |
| Bromine index | 70 | 70 | 72 |

The data in Table 4 show that the use of soda in the presence of an alcohol (isopropanol, test 7) gives results which are substantially equivalent to the use of soda concentrated in water (test 3), whereas 3.8 g of soda are advantageously used for 286 g of feedstock HPP2 in test 7 versus 14.0 g of sodium hydroxide for 468.9 g of feedstock HPP2 in test 3.

The speciation of the hydrocarbon families allowed showing that the treatment method using a strong base in the presence of an alcohol did not significantly affect the composition profile of the plastic pyrolysis oil (Table 5). Results presented in arbitrary units, relative values.

TABLE 5

| | Test | |
|---|---|---|
| | HPP2 | 7 |
| n- and | 45.3 | 45.2 |
| iso-paraffins | | |
| Olefins | 34.2 | 35 |
| Mono-naphthenes | 4.3 | 4.6 |
| Poly-naphthenes | 4.7 | 4.7 |
| Mono-aromatics | 9.8 | 10.9 |
| Di-aromatics | 0.58 | 0.62 |
| Tri-aromatics | 0.08 | 0.16 |

The pyrolysis oil can either be used as is, or optionally dried on an adsorbent such as a molecular sieve or an anhydrous salt, for example Na₂SO₄, then is distilled under reduced pressure in order to eliminate any possible trace of solid, for example of strong base, of adsorbent residue, of anhydrous/hydrated salt or of gums.

Alternatively, the mixture directly from the autoclave could be distilled under reduced pressure up to a pressure of 1 mbar and at a temperature of 200 to 250° C. to collect a purified pyrolysis oil as a distillate and a residue comprising the strong base associated with impurities.

### Example 2: Two-Step Hydrotreatment and Steam Cracking of the Product of Example 1

One of the seven purified and washed pyrolysis oils of Example 1 can be hydrotreated in two steps according to the following procedure:

The purified and washed pyrolysis oil can be introduced into a first hydrotreatment section (HDT1) essentially to hydrogenate diolefins and is operated in liquid phase. This step can comprise a plurality of series and/or parallel reactors if guard reactors are used upstream or downstream of the first hydrogenation reactor. These guard reactors can allow reducing the concentration of certain undesirable chemical species and/or elements such as chlorine, silicon and metals. Particularly undesirable metals include Na, Ca, Mg, Fe and Hg.

A second hydrotreatment section (HDT2) is dedicated to the hydrogenation of olefins and the demetallation (HDM), desulphurisation (HDS), denitrogenation (HDN) and deoxygenation (HDO). HDT2 is operated in the gas phase. This section consists of one or more reactors operated in series, lead-lag or in parallel.

As the hydrotreating reactions in the HDT1 and HDT2 sections are exothermic, a quenching with cold hydrogen can be used to moderate the increase in temperature and control the reaction.

Isolated, lead-lag, series or parallel guard reactors can be considered according to the nature and amount of the contaminant in the stream to be treated.

In the event that the treatment of Example 1 would not allow obtaining a sufficient reduction in impurities, guard reactors to eliminate chlorine and silicon can be operated in the gas phase. Silicon can also be trapped on the upper bed of a reactor of the HDT2 section or separately, upstream or downstream by the treatment of hot gases leaving the HDT2 section.

Chlorine and mercury can be separated by guard reactors in liquid or gas phase.

There may be intermediate quenches between the beds or between the HDT1 and HDT2 reactors or no quenching. In the latter case, a recycling of a portion of the stream exiting HDT1 or HDT2 must be carried out to control the temperature. A strict control of the temperature in HDT1 must be carried out, in order to avoid the clogging of the reactor and the deterioration of the catalytic hydrogenation conditions.

The operating pressure in each of the hydrotreatments HDT1 and HDT2 is of 5-60 bars, preferably 20-30 bars for HDT1 and 20-140 bars, preferably 30-60 bars for HDT2, typically 30-40 bars for HDT2.

Typical temperature range at the HDT1 inlet at the start of run (SOR): 150-200C. The catalyst for HDT1 usually comprises Pd (0.1-10% by weight) and/or Ni (0.1-60% by weight) and/or NiMo (0.1-60% by weight).

Typical temperature range at the HDT2 inlet at the start of run (SOR): 200-340° C. Typical HDT2 outlet temperature range (SOR): 300-380° C., up to 450° C. The catalyst for HDT 2 usually comprises a NiMo (any type of commercial catalyst for refining or petrochemical applications), potentially a CoMo in very last beds at the bottom of the reactor (all types of commercial catalyst for refining or petrochemical applications).

The upper bed of HDT2 should preferably be operated with a NiMo having a hydrogenating capacity as well as a silicon trapping capacity. An upper bed of this type can be considered as an adsorbent as well as a metal trap also having a HDN activity and a hydrogenating capacity. An example of upper bed acceptable for this function comprises the commercially available NiMo catalyst adsorbents such as ACT971, ACT981 from Axens or equivalents from Haldor Topsoe, Axens, Criterion, etc. It is possible to have two separate beds in a HDT2 reactor, with quenching between the two beds or between the two reactors, if the two beds are in two distinct reactors, or no quenching at all. Ideally, intermediate quenching is performed by means of cold effluent of HDT2 or by a supply of cold hydrogen, that is to say at a temperature generally ranging from 15 to 30° C., in order to control the exotherm of HDT2. A dilution by recycling of the hydrocarbon stream to the upper bed of HDT2 is not recommended due to the increased risks of fouling of the bed. The feedstock arriving on the HDT2 catalyst should be completely vaporised at any time, including at variable speed as is the case during starts. Sending liquid hydrocarbons on the upper portion of a HDT2 reactor can generate fouling and an increase in the pressure difference between the inlet and the outlet of said HDT2 reactor and lead to a premature shutdown.

Depending on the metals present in the pyrolysis oil to be hydrotreated, a hydrodemetallation catalyst, for example commercial, can be added on the upper bed of the HDT2 section in order to protect the lower catalytic beds from deactivation.

The hydrotreated pyrolysis oil leaving the HDT2 section can be used as is or fractionated according to distillation temperature ranges, to feed a steam cracker, an FCC, a hydrocracker, a catalytic reformer or a pool of fuels or combustibles such as LPG, gasoline, jet, diesel, fuel oil.

Alternatively, the treated pyrolysis oil leaving the HDT2 section undergoes an additional purification step by passing over a capture mass such as an adsorbent, for example (i) a silica gel, (ii) a clay, (iii) a pounded clay, (iv) apatite, (v) hydroxyapatite and the combinations thereof, (vi) an alumina for example an alumina obtained by precipitating boehmite, a calcined alumina such as Ceralox® from Sasol, (vii) boehmite, (viii) bayerite, (ix) hydrotalcite, (x) spinel such as Pural® or Puralox from Sasol, (xi) a promoted alumina, for example Selexsorb® from BASF, an acid promoted alumina, an alumina promoted by a zeolite and/or by a metal such as Ni, Co, Mo or a combination of at least two of them, (xii) an acid-treated clay such as Tonsil® from Clariant, (xiii) a molecular sieve in the form of an aluminosilicate containing an alkali or alkaline earth cation for example the sieves 3A, 4A, 5A, 13X, for example marketed under the brand Siliporite® from Ceca, (xiv) a zeolite, (xv) an activated carbon, or the combination of at least two adsorbents, the adsorbent or the at least two adsorbents retaining at least 20% by weight, preferably at least 50% by weight of at least one element from F, Cl, Br, I, O, N, S, Se, Si, P, As, Fe, Ca, Na, K, Mg and Hg and/or water. Ideally, the adsorbent is regenerative, has a specific surface area of at least 200 m²/g and is operated in a fixed bed reactor at less than 100° C. with a HSV of 0.1 to 10 h⁻¹.

1. A method for reducing the concentration of heteroatoms of a composition comprising a plastic pyrolysis oil containing at least 20 ppm by mass of chlorine as measured according to standard ASTM D7359-18, comprising:
(a). contacting said composition with 0.1-50% by mass of a strong base comprising an alkali or alkaline earth metal cation in the solid state, for at least 1 minute at a temperature of at most 450° C.,
(b). a separation between the strong base comprising the alkali or alkaline earth metal cation and the product resulting from contacting said composition by washing with a polar solvent immiscible with the product resulting from step (a).

2. The method according to claim 1, wherein the composition further comprises a biomass pyrolysis oil such as Panicum virgatum, a tall oil, a waste edible oil, an animal fat, a vegetable oil such as rapeseed oil, canola oil, palm oil, soybean oil, an oil extracted from an algae, an oil extracted from a fermentation of oleaginous microorganisms such as oleaginous yeasts, a biomass pyrolysis oil such as a lignocellulosic biomass such as a wood, paper and/or cardboard pyrolysis oil, an oil obtained by pyrolysis of crushed used furniture, an elastomer pyrolysis oil for example optionally vulcanised latex or tires, as well as mixtures thereof.

3. The method according to claim 1, further comprising a step in which:
(c) the product resulting from the washing in step (b) is subjected to a (i) filtration, (ii) distillation, (iii) extraction with a solvent, or (iv) the combination of two or three of steps (i) to (iii).

4. The method according to claim 1, wherein the contact is performed for a period of 1 minute to 48 hours, preferably of 5 minutes to 2 hours, at a temperature of 50 to 450° C., preferably of 90 to 350° C., more preferably of 150 to 350° C. and at an absolute pressure of 0.1 to 100 bars, preferably of 1 to 50 bars.

5. The method according to claim 1, wherein the washing of step (b) is performed with a polar solvent selected from (i) glycol ethers, including in particular polyethylene glycol of chemical formula HO—(CH₂—CH₂—O)ₙ—H with a mass average molar mass of 90 to 800 g/mol, for example diethylene glycol and tetraethylene glycol, polypropylene glycol of chemical formula H[OCH(CH₃)CH₂]ₙOH with a mass average molar mass of 130 to 800 g/mol, for example dipropylene glycol and tetrapropylene glycol, (iii) dialkyl formamides, in which the alkyl group can comprise 1 to 8 or 1 to 3 carbon atoms, in particular N,N-dimethyl formamide (DMF), (iii) dialkyl sulfoxides, in which the alkyl group can comprise 1 to 8 or 1 to 3 carbon atoms, in particular dimethyl sulfoxide (DMSO) and sulfolane, (iv) the compounds comprising a furan ring, (v) cyclic carbonate esters, comprising in particular 3 to 8 or 3 to 4 carbon atoms, in particular propylene carbonate and ethylene carbonate, (vi) water and mixtures thereof.

6. The method according to claim 1, wherein the washing of step (b) is performed with water.

7. The method according to claim 1, wherein the strong base is selected from LiOH, NaOH, CsOH, Ba(OH)₂, Na₂O, KOH, K₂O, CaO, Ca(OH)₂, MgO, Mg(OH)₂ and mixtures thereof.

8. The method according to claim 1, wherein:
(d) the product resulting from step (b) or (c) undergoes a catalytic hydrogenation in one or two steps.

9. The method according to claim 8, wherein the catalytic hydrogenation of step (d) is performed in a first step (d-1) in which the product resulting from step (b) or (c) is hydrogenated at a temperature comprised between 20 and 200° C., preferably between 3° and 90° C. in the presence of hydrogen at an absolute pressure comprised between 5 and 60 bars, preferably between 20 and 30 bars and in the presence of a hydrogenation catalyst comprising Pd (0.1-10% by weight) and/or Ni (0.1-60% by weight) and/or NiMo (0.1-60% by weight) and in a second step (d-2) in which the effluent resulting from step (d-1) is hydrogenated at a temperature comprised between 20° and 450° C., preferably between 200 and 340° C. in the presence of hydrogen at an absolute pressure comprised between 20 and 140 bars, preferably between 30 and 60 bars and in the presence of a hydrogenation catalyst comprising NiMo (0.1-60% by weight) and/or CoMo (0.1-60% by weight).

10. The method according to claim 1, wherein the product resulting from step (b) or (c) or the effluent resulting from step (d) is purified by passing over a solid adsorbent in order to reduce the content of at least one element from F, Cl, Br, I, O, N, S, Se, Si, P, As, Fe, Ca, Na, K, Mg and Hg and/or the water content.

11. The method according to claim 10, wherein the adsorbent is operated in regenerative or non-regenerative mode, at a temperature which is lower than 400° C., preferably lower than 100° C., more preferably lower than 60° C. selected from: (i) a silica gel, (ii) a clay, (iii) a pounded clay, (iv) apatite, (v) hydroxyapatite and the combinations thereof, (vi) an alumina for example an alumina obtained by precipitating boehmite, a calcined alumina, (vii) boehmite, (viii) bayerite, (ix) hydrotalcite, (x) spinel, (xi) a promoted alumina, an acid promoted alumina, an alumina promoted by a zeolite and/or by a metal such as Ni, Co, Mo or a combination of at least two of them, (xii) an acid-treated clay, (xiii) a molecular sieve in the form of an aluminosilcate containing an alkali or alkaline earth cation for example the sieves 3A, 4A, 5A, 13X, (xiv) a zeolite, (xv) an activated carbon, or the combination of at least two adsorbents, the adsorbent or the at least two adsorbents retaining at least 20% by weight, preferably at least 50% by weight of at least one element from F, Cl, Br, I, O, N, S, Se, Si, P, As, Fe, Ca, Na, K, Mg and Hg and/or water.

12. The method according to claim 11, wherein the adsorbent is regenerative, has a specific surface area of at least 200 m²/g and is operated in a fixed bed reactor at less than 100° C. with a HSV of 0.1 to 10 h⁻¹.

13. The method according to claim 1, wherein at least one portion of the product resulting from step (b) or (c) or the effluent resulting from step (d) is:
(e) treated in a steam cracker, and/or
(f) treated in a fluidised bed catalytic cracker, or
(g) treated in a hydrocracker, and/or
(h) treated in a catalytic hydrogenation unit, and/or
(i) used as is or separated into streams usable for the preparation of fuels and combustibles such as LPG, gasoline, diesel, heavy fuel oil and/or for the preparation of lubricants.
